(19) United States
(12) Patent Application Publication
(10) Pub. No.: US 2024/0118801 A1
(43) Pub. Date: Apr. 11, 2024

(54) DATA LABELING METHOD, APPARATUS, DEVICE, COMPUTER-READABLE STORAGE MEDIUM AND PRODUCT

(71) Applicant: Beijing Zitiao Network Technology Co., Ltd., Haidian District, Beijing (CN)

(72) Inventors: Dachang LIU, Beijing (CN); Huaizhi QIU, Beijing (CN); Chengrong CHEN, Beijing (CN)

(21) Appl. No.: 18/554,072

(22) PCT Filed: Apr. 29, 2022
(86) PCT No.: PCT/CN2022/090766

§ 371 Date: Oct. 5, 2023

(30) Foreign Application Priority Data
May 14, 2021 (CN) 202110529723.0

(51) Int. Cl. G06F 3/0486; G06F 3/0481; G06F 9/451

(52) U.S. Cl. CPC G06F 3/0486; G06F 3/0481; G06F 9/451

(57) ABSTRACT

Embodiments of the present disclosure provide a data labeling method, an apparatus, a device, a computer-readable storage medium and a product. The method includes: in response to a trigger operation performed by a user on a preset labeling button on a display interface, entering a labeling mode, the display interface including: graphical information of at least one analysis object arranged along a time axis; in response to a selection operation performed by the user on at least one time range of the graphical information corresponding to the at least one analysis object within the display interface, determining a target labeling area corresponding to the selection operation of each time range, each time range being used for representing a different time period on the time axis; in response to a labeling operation on at least one target labeling area, generating labeling information corresponding to the at least one target labeling area.

### CROSS-REFERENCE TO RELATED APPLICATION

The present application is a National Stage of International Application No. PCT/CN2022/090766, filed on Apr. 29, 2022, which claims priority to Chinese Patent Application No. 202110529723.0, filed with China National Intellectual Property Administration on May 14, 2021 and entitled “DATA LABELING METHOD, APPARATUS, DEVICE, COMPUTER-READABLE STORAGE MEDIUM AND PRODUCT”. The above applications are hereby incorporated by reference in their entireties.

### TECHNICAL FIELD

Embodiments of the present disclosure relate to the field of data processing technology and, in particular, to a data labeling method, an apparatus, a device, a computer-readable storage medium and a product.

### BACKGROUND

For existing network performance analysis, it is usually needed to analyze multiple performance defect segments. In order to realize acquisition of a performance defect segment, in the prior art, a technician generally locates a defect segment based on experience, and then records time corresponding to the defect segment manually or performs a screenshot taking operation on the defect segment manually.

### SUMMARY

Embodiments of the present disclosure provide a data labeling method, an apparatus, a device, a computer-readable storage medium and a product to solve the technical problem that recording is performed completely manually in an existing data labeling method and efficiency and accuracy are relatively low.

In a first aspect, an embodiment of the present disclosure provides a data labeling method, including:
in response to a trigger operation performed by a user on a preset labeling button on a display interface, entering a labeling mode, the display interface including: graphical information of at least one analysis object arranged along a time axis;
in response to a selection operation performed by the user on at least one time range of the graphical information corresponding to the at least one analysis object within the display interface, determining a target labeling area corresponding to the selection operation of each time range, each time range being used for representing a different time period on the time axis;
in response to a labeling operation on at least one target labeling area, generating labeling information corresponding to the at least one target labeling area.

In a second aspect, an embodiment of the present disclosure provides a data labeling apparatus, including:
a display module, configured to: in response to a trigger operation performed by a user on a preset labeling button on a display interface, enter a labeling mode, the display interface including: graphical information of at least one analysis object arranged along a time axis;
a determining module, configured to: in response to a selection operation performed by the user on at least one time range of the graphical information corresponding to the at least one analysis object within the display interface, determine a target labeling area corresponding to the selection operation of each time range, each time range being used for representing a different time period on the time axis;
a labeling module, configured to: in response to a labeling operation on at least one target labeling area, generate labeling information corresponding to the at least one target labeling area.

In a third aspect, an embodiment of the present disclosure provides an electronic device, including: at least one processor, a memory and a display;
the processor, the memory and the display are interconnected through a circuit;
the memory stores computer execution instructions; the display is configured to display a display interface;
the at least one processor executes the computer execution instructions stored in the memory, to cause the at least one processor to execute the data labeling method according to the first aspect and various possible designs of the first aspect.

In a fourth aspect, an embodiment of the present disclosure provides a computer-readable storage medium. The computer-readable storage medium stores computer execution instructions therein, and when a processor executes the computer execution instructions, the data labeling method according to the first aspect and various possible designs of the first aspect is implemented.

In a fifth aspect, the embodiment of the present disclosure provides a computer program product including a computer program. When the computer program is executed by a processor, the data labeling method according to the first aspect and various possible designs of the first aspect is implemented.

### BRIEF DESCRIPTION OF DRAWINGS

In order to more clearly illustrate the technical solutions in embodiments of the present disclosure or in the prior art, the following will briefly introduce the drawings that need to be used in the description of the embodiments or the prior art. Obviously, the accompanying drawings in the following description are some embodiments of the present disclosure. Those skilled in the art can also obtain other drawings based on these drawings without creative effort.

FIG. 1 is a schematic flowchart of a data labeling method provided by Embodiment 1 of the present disclosure.

FIG. 2 is a diagram of interface interaction provided by an embodiment of the present disclosure.

FIG. 3 is a schematic flowchart of a data labeling method provided by Embodiment 2 of the present disclosure.

FIG. 4 is a schematic diagram of another display interface provided by an embodiment of the present disclosure.

FIG. 5A and FIG. 5B are schematic diagrams of another display interface provided by an embodiment of the present disclosure.

FIG. 6 is a schematic diagram of another display interface provided by an embodiment of the present disclosure.

FIG. 7 is a schematic diagram of another display interface provided by an embodiment of the present disclosure.

FIG. 8 is a schematic structural diagram of a data labeling apparatus provided by Embodiment 3 of the present disclosure.

FIG. 9 is a schematic structural diagram of an electronic device provided by Embodiment 4 of the present disclosure.

FIG. 10 is a schematic structural diagram of another electronic device provided by Embodiment 5 of the present disclosure.

### DETAILED DESCRIPTION OF EMBODIMENTS

In order to make the purpose, technical solutions and advantages of embodiments of the present disclosure clearer, the technical solutions in the embodiments of the present disclosure will be clearly and completely described below in combination with the accompanying drawings of the embodiments of the present disclosure. It is clear that the embodiments described are a part of the embodiments of the present disclosure, and not all of them. Based on the embodiments in the present disclosure, all other embodiments obtained by those skilled in the art without creative effort fall within the scope of protection of the present disclosure.

Aiming at the above-mentioned technical problem that recording is performed completely manually in an existing data labeling method and efficiency and accuracy are relatively low, the present disclosure provides a data labeling method, an apparatus, a device, a computer-readable storage medium and a product.

It should be noted that the data labeling method, the apparatus, the device, the computer-readable storage medium and the product provided by the present disclosure can be applied to any data labeling scenario.

For existing network performance analysis, it is usually needed to analyze multiple performance defect segments. In order to realize acquisition of a performance defect segment, in the prior art, a technician generally locates a defect segment based on experience, and then records time corresponding to the defect segment manually or performs a screenshot taking operation on the defect segment manually. Recorded defect information is stored within a preset storage path, where the defect information includes time information or a screenshot. However, when the above method is used to record defect segments, on the one hand, defect recording operations rely on manual operations heavily, and efficiency is relatively low. In addition, since fault segments and corresponding defect information thereof are stored in different areas, the two pieces of information cannot be viewed at the same time, resulting in relatively low efficiency of defect segment viewing. In other words, since a piece of network analysis result data of a product to be tested may often have a segment with a performance defect, it is necessary to perform a labeling operation on the segment with the performance defect, in order to realize location and optimization of network, performance and other problems of the product to be tested. An existing labeling method generally involves that a user takes a screenshot of a performance defect segment manually or records the time of the performance defect segment manually, and the screenshot and time information are stored to a preset storage path. However, the above method is often inefficient, and labeling information cannot be displayed on the same screen as a network request, resulting in relatively low efficiency of user performance analysis.

In the process of solving the above technical problem, the inventors found through research that in order to improve the efficiency of labeling of a performance defect segment, determination of a time range of the performance defect segment can be achieved by means of interface interaction. Specifically, a labeling mode can be entered in response to a trigger operation performed by a user on a preset labeling button on a display interface, and under the labeling mode, the user can select graphical information of a time range corresponding to at least one analysis object, so as to determine a target labeling area corresponding to the time range. After determining the target labeling area, in response to a labeling operation on at least one target labeling area, labeling information corresponding to the target labeling area of the at least one analysis object can be generated.

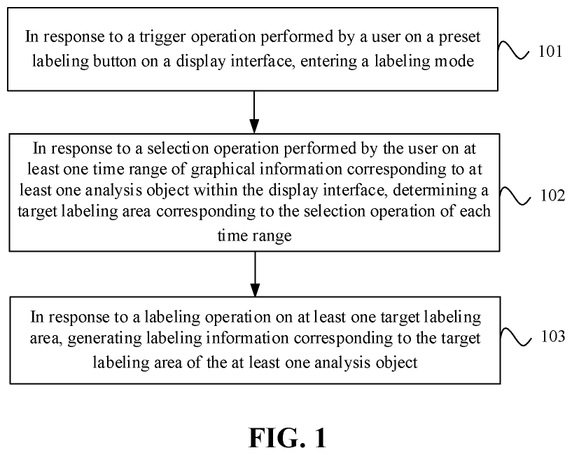

FIG. 1 is a schematic flowchart of a data labeling method provided by Embodiment 1 of the present disclosure. As shown in FIG. 1, the method includes the following steps.

Step 101: in response to a trigger operation performed by a user on a preset labeling button on a display interface, entering a labeling mode, the display interface including: graphical information of at least one analysis object arranged along a time axis.

An executive entity of this embodiment is a data labeling apparatus, and the data labeling apparatus may be coupled into a server.

In this implementation, the data labeling apparatus can control the display interface to display the graphical information of at least one analysis object arranged along the time axis, where the analysis object specifically includes a network request waterfall diagram, a network performance graph, etc.

In addition, the labeling button is also provided on the display interface, and when it is detected that the user triggers the labeling button, the labeling mode is entered in response to the trigger operation performed by the user on the labeling button.

Optionally, under the labeling mode, all operations within the graphical information of at least one analysis object can be blocked, and in order to improve the labeling efficiency, the graphical information of at least one analysis object can be controlled to be highlighted to be distinguished from other contents and facilitate the user's labeling operation. For example, transparency of a graphical information area of a non-analysis object can be reduced. In addition, a mouse cursor can be switched to a differentiating style such as a cross shape to improve the user's labeling accuracy as well as labeling efficiency.

The analysis object may specifically be network analysis result data.

Step 102: in response to a selection operation performed by the user on at least one time range of the graphical information corresponding to at least one analysis object within the display interface, determining a target labeling area corresponding to the selection operation of each time range, each time range being used for representing a different time period on the time axis.

In this embodiment, the user can determine the target labeling area through interface interaction, where the target labeling area may specifically be an area corresponding to a network request segment with a performance defect, and respective time ranges are used for representing different time periods on the time axis.

Specifically, the user can determine an area to be selected according to an actual situation, and in response to the selection operation performed by the user on at least one time range of the graphical information corresponding to at least one analysis object within the display interface, at least one target labeling area corresponding to the time range selected by the user is determined.

It should be noted that, since there may be multiple segments with performance defects within a segment of network request, at least one target labeling area can be determined according to multiple selection operations performed by the user.

Step 103: in response to a labeling operation on at least one target labeling area, generating labeling information corresponding to the at least one target labeling area.

In this embodiment, in order to further complete the labeling operation on at least one target labeling area, the labeling information corresponding to the at least one target labeling area can be generated in response to the labeling operation performed by the user on the at least one target labeling area. The labeling information may include at least one of a tag type, a name, a time range, and remark information corresponding to the target labeling area.

Specifically, the same tag type may correspond to the same piece of labeling information, that is, one piece of labeling information may include multiple different pieces of sub-labeling information, and each piece of sub-labeling information corresponds to a different target labeling area and labeling content.

It should be noted that the labeling information can be displayed in the same display interface with the target labeling area, so that a technician can more intuitively locate and analyze a current analysis object with a performance defect in a process of subsequent performance and network analysis, to improve processing efficiency.

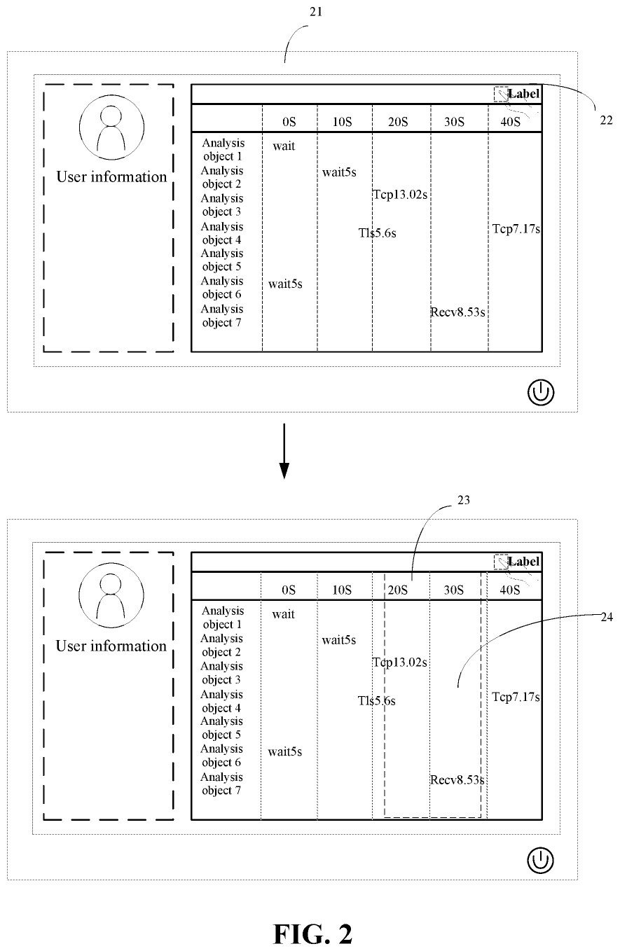

FIG. 2 is a diagram of interface interaction provided by an embodiment of the present disclosure. As shown in FIG. 2, a user can trigger a preset labeling button 22 on a display interface 21. In response to the trigger operation, the display interface can jump to a labeling mode. Under the labeling mode, all operations within graphical information 23 of analysis objects can be blocked. Optionally, in order to facilitate user operations, the graphical information 23 of the analysis objects can be controlled to be in a highlighted mode. The user can perform a selection operation on at least one time range of the graphical information corresponding to at least one analysis object on the display interface to determine a corresponding target labeling area 24.

With the data labeling method provided in this embodiment, by displaying the graphical information of at least one analysis object arranged along the time axis on the display interface, the labeling mode can be entered in response to the trigger operation performed by the user on the preset labeling button on the display interface, and under the labeling mode, the user can select at least one time range of the graphical information corresponding to the at least one analysis object, so as to determine the target labeling area corresponding to the selection operation of each time range. After determining the target labeling area, the labeling information corresponding to at least one target labeling area can be generated in response to the labeling operation on the at least one target labeling area. The labeling information can include time selected by the user through interface interaction. In addition, the labeling information and the target labeling area can be displayed on the same display interface at the same time, which is convenient for a technician to analyze and process a performance defect segment subsequently.

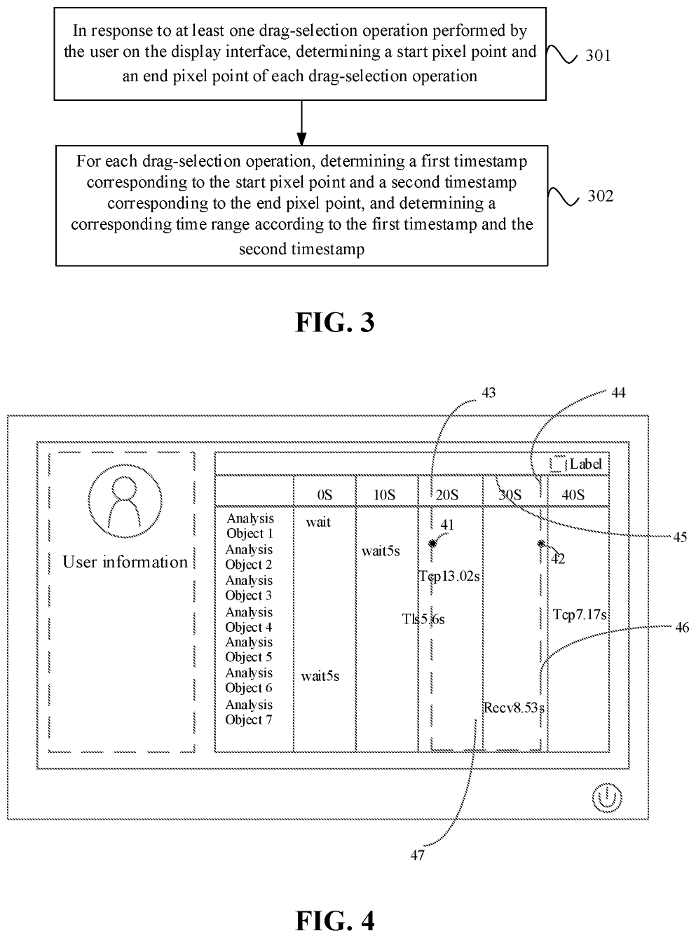

FIG. 3 is a schematic flowchart of a data labeling method provided in Embodiment 2 of the present disclosure. On the basis of Embodiment 1, step 102 specifically includes:

Step 301, in response to at least one drag-selection operation performed by the user within the display interface, determining a start pixel point and an end pixel point of each drag-selection operation.

Step 302, for each drag-selection operation, determining a first timestamp corresponding to the start pixel point and a second timestamp corresponding to the end pixel point, and determining a corresponding time range according to the first timestamp and the second timestamp.

In this embodiment, the time range of the target labeling area can be determined according to the drag-selection operation performed by the user on the display interface. Specifically, in response to at least one drag-selection operation performed by the user within the display interface, the start pixel point and the end pixel point of each drag-selection operation can be determined. For each drag-selection operation, the first timestamp corresponding to the start pixel point and the second timestamp corresponding to the end pixel point are determined respectively, and a time period between the first timestamp and the second timestamp is determined as the time range.

Optionally, a pixel point within the display interface corresponds to a timestamp, and the timestamp can be accurate to a millisecond level, which improves the accuracy of subsequent performance analysis.

Further, on the basis of any one of the above embodiments, the graphical information corresponding to the at least one analysis object is sequentially arranged in rows in the display interface, and the graphical information corresponding to each analysis object extends along a direction of the time axis.

Determining the corresponding target labeling area in step 102 includes:
determining the corresponding target labeling area by taking the respective time range as a width and taking a height occupied by the graphic information corresponding to all analysis objects as a length.

In this embodiment, detail information of multiple network requests within a preset time period is sequentially arranged in the display interface, and the graphical information corresponding to each analysis object is represented by the time axis. After the time range is determined, the time range can be used as the width, and the height occupied by the graphical information corresponding to all the analysis objects can be used as the length. The target labeling area is determined according to the length and the width.

FIG. 4 is a schematic diagram of another display interface provided by an embodiment of the present disclosure. As shown in FIG. 4, a user can perform a time range selection by dragging. Specifically, a start pixel point 41 and an end pixel point 42 of a drag-selection operation can be determined, and a time period between a first timestamp 43 corresponding to the start pixel point 41 and a second timestamp 44 corresponding to the end pixel point 42 is taken as a time range. In addition, a corresponding target labeling area 47 can be determined by taking the time range as a width 45 and taking a height occupied by the graphical information corresponding to all analysis objects as a length 46.

With the data labeling method provided in this embodiment, the time range of the target labeling area is determined according to the drag-selection operation performed by the user on the display interface, thus enabling fast and accurate determination of the range of the target labeling area, realizing automatic generation of the time of the target labeling area, and allowing to be accurate to the millisecond level to improve the accuracy of subsequent analysis and processing.

Further, on the basis of any one of the above embodiments, the method also includes:
controlling the time axis to move in a lateral direction of the drag-selection operation, if it is detected that a pixel point where a cursor is located goes out of a current labeling range of the display interface during the drag-selection operation.

In this embodiment, when a time range of a drag-selection operation is relatively large and goes beyond the current labeling range of the display interface, an update of the content displayed on the display interface can be controlled so as to realize the determination of the complete time range of the target labeling area.

Specifically, whether the pixel point where the cursor is located goes out of the labeling range of the current display interface during the drag-selection operation is detected, and if so, the time axis can be controlled to move in the lateral direction of the drag-selection operation.

As an implementable manner, it is possible to detect whether a dragging speed exceeds a preset speed threshold during the drag-selection operation, and if so, the time axis can be controlled to move in the lateral direction of the drag-selection operation.

Further, on the basis of any one of the above embodiments, any two target labeling areas do not overlap.

In this embodiment, when the user selects multiple target labeling areas, any two of the target labeling areas can be controlled not to overlap. It should be noted that boundaries of two target labeling areas may overlap because an interval between two performance defect segments may be relatively short in a practical application.

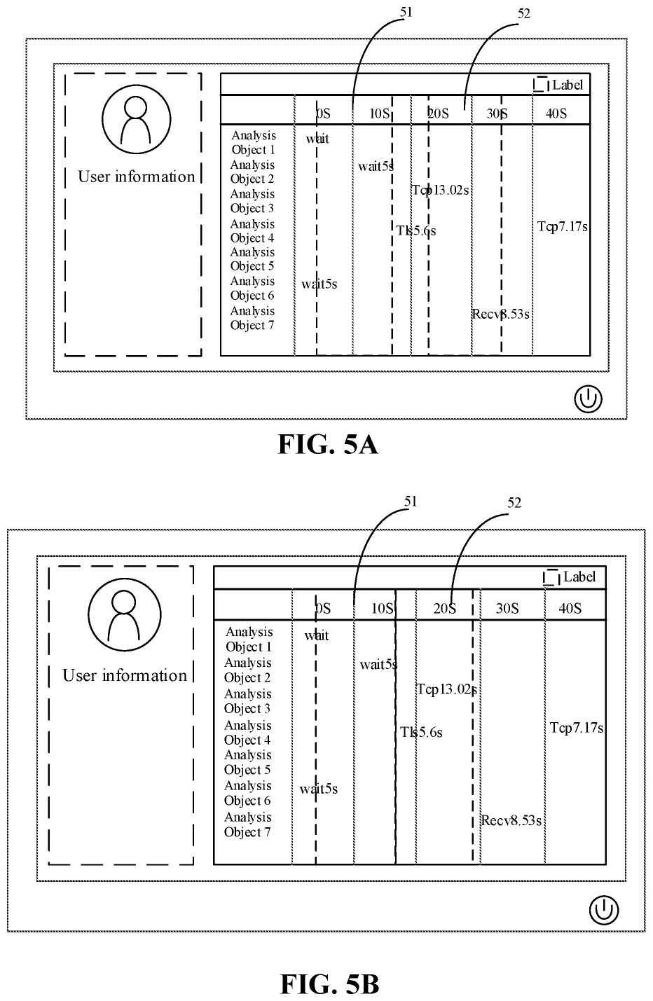

FIG. 5A and FIG. 5B are schematic diagrams of another display interface provided by an embodiment of the present disclosure. As shown in FIG. 5A, a target labeling area 51 and a target labeling area 52 do not overlap. Optionally, as shown in FIG. 5B, boundaries of the target labeling area 51 and the target labeling area 52 may overlap.

Further, on the basis of any one of the above embodiments, after step 102, the method also includes:
in response to a drag-selection operation performed by the user on a left area boundary or a right area boundary of the target labeling area, adjusting the time range corresponding to the target labeling area; or,
in response to a trigger operation performed by the user on a preset direction key, adjusting the time range corresponding to the target labeling area.

In this embodiment, after the drag-selection operation on the target labeling area is completed, an adjusting operation can also be performed on the time range corresponding to the target labeling area according to actual needs. Specifically, the time range corresponding to the target labeling area may be adjusted in response to the drag-selection operation performed by the user on the left area boundary or the right area boundary of the target labeling area. In a practical application, the user can perform a dragging operation by mouse clicking on the left area boundary or the right area boundary, so as to realize a position adjusting operation on the left area boundary or the right area boundary to achieve adjustment of the time range.

Optionally, the preset direction key may also be used to perform an adjusting operation on the time range corresponding to the target labeling area. Specifically, the time range corresponding to the target labeling area may be adjusted in response to the trigger operation performed by the user on the preset direction key.

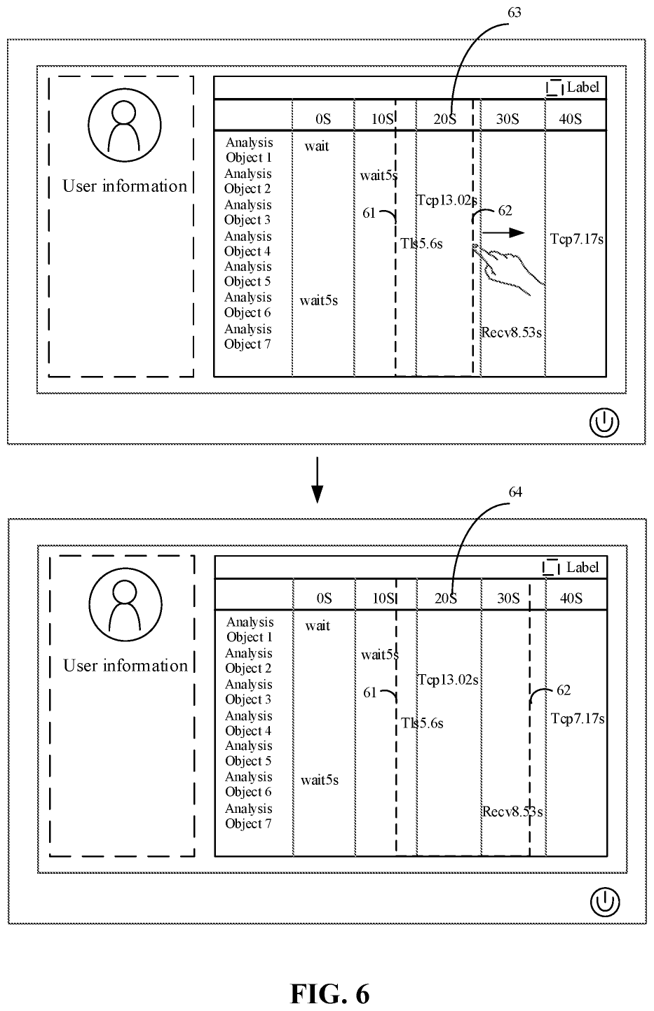

FIG. 6 is a schematic diagram of another display interface provided by an embodiment of the present disclosure. As shown in FIG. 6, a user can achieve adjustment of a time range 63 through a drag-selection operation on a left area boundary 61 or a right area boundary 62 of a target labeling area to obtain the adjusted time range 64.

Further, on the basis of any one of the above embodiments, adjusting the time range corresponding to the target labeling area in response to the trigger operation performed by the user on the preset direction key includes:
in response to the trigger operation performed by the user on the preset direction key, controlling an area boundary of the target labeling area which matches the direction key to move, to adjust the time range corresponding to the target labeling area;
or,
in response to a trigger operation performed by the user on any area boundary of the target labeling area and the trigger operation performed by the user on the preset direction key, controlling the area boundary to move in a direction corresponding to the direction key, to adjust the time range corresponding to the target labeling area.

In this embodiment, in a process of the user adjusting the time range via the direction key, a left direction key can be used to control the left area boundary, and a right direction key can be used to control the right area boundary. Specifically, in response to the trigger operation performed by the user on the preset direction key, the area boundary of the target labeling area which matches the direction key can be controlled to move, to adjust the time range corresponding to the target labeling area.

Optionally, the user may also select an area boundary with the mouse and control the selected area boundary to move towards left and right through the preset direction keys to achieve adjustment of the time range. Specifically, in response to the trigger operation performed by the user on any area boundary of the target labeling area and the trigger operation performed by the user on the preset direction key, the area boundary is controlled to move in the direction corresponding to the direction key, to adjust the time range corresponding to the target labeling area.

With the data labeling method provided in this embodiment, the adjustment of the time range corresponding to the target labeling area can be realized quickly and accurately through the adjusting operation performed by the user on the area boundary with the mouse or the direction keys, which further improves the accuracy and efficiency of data labeling.

Further, on the basis of any one of the above embodiments, after step 102, the method also includes:
displaying a labeling operation execution interface of the target labeling area, the labeling operation execution interface including at least one of a tag type, a name, a time range, and remark information corresponding to the target labeling area; and/or
after generating the labeling information corresponding to the at least one target labeling area, the method also includes:
in response to a trigger operation performed by the user on an edit control, displaying a modifying operation execution interface of the target labeling area, the modifying operation execution interface including at least one of a tag type, a name, a time range, and remark information corresponding to the target labeling area.

In this embodiment, a labeling completing button may be provided on the display interface, and the user can trigger the labeling completing button to realize the labeling operation on the target labeling area after completing the selection of at least one target labeling range. Specifically, the labeling operation execution interface can be displayed on the display interface, where the labeling operation execution interface includes at least one of the tag type, the name, the time range and the remark information corresponding to the target labeling area. The user can fill in the above information according to an actual situation.

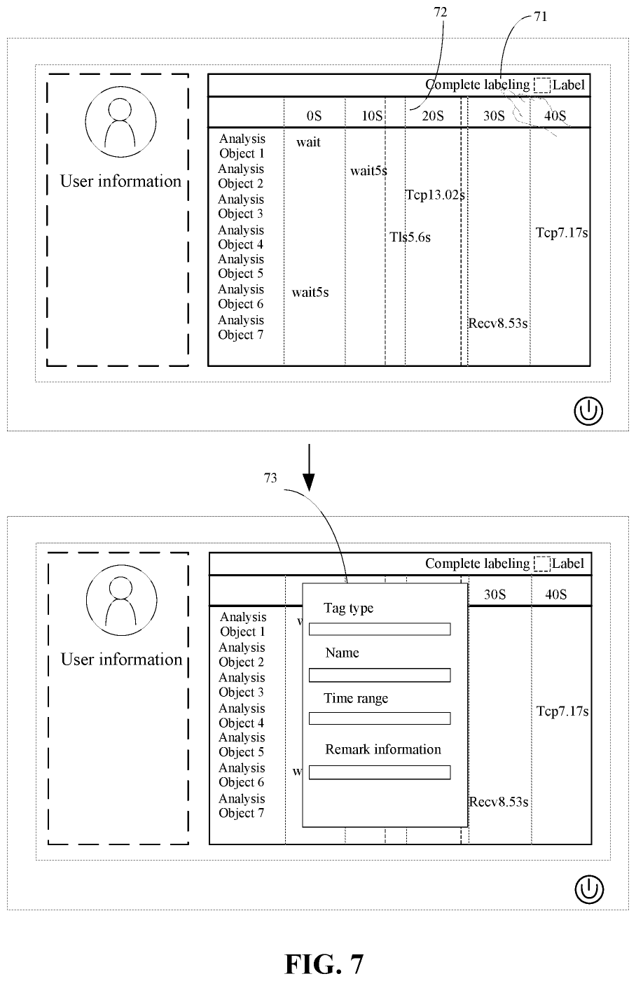

FIG. 7 is a schematic diagram of another display interface provided by an embodiment of the present disclosure. As shown in FIG. 7, a user can realize a labeling operation on a target labeling area 72 by triggering a preset labeling completing button 71 on the display interface. Specifically, a labeling operation execution interface 73 of the target labeling area can be displayed, and the labeling operation execution interface of the target labeling area includes at least one of a tag type, a name, a time range, and remark information corresponding to the target labeling area.

In addition, after filling in the content of the labeling operation execution interface, the user can also perform a modifying edit operation on the above information. Specifically, in response to the trigger operation performed by the user on the edit control, the modifying operation execution interface of the target labeling area can be displayed, and the modifying operation execution interface includes at least one of the tag type, the name, the time range and the remark information corresponding to the target labeling area.

Further, on the basis of any one of the above embodiments, after step 103, the method also includes:
displaying the labeling information corresponding to the at least one target labeling area in a preset first display area; and/or,
for each piece of the labeling information, displaying, within a preset second display area, the labeling information at a position corresponding to the time range according to the time range in the labeling information.

In this embodiment, the labeling information corresponding to the at least one target labeling area can be displayed in the preset first display area, or for each piece of the labeling information, the labeling information can be displayed within the preset second display area at the position corresponding to the time range according to the time range in the labeling information. Optionally, the first display area may be located in a right toolbar of the graphical information of the at least one analysis object, and the second display area may be located on a lower side of the graphical information of the at least one analysis object.

Further, the labeling information of one tag type includes multiple different pieces of sub-labeling information, and each piece of sub-labeling information corresponds to labeling content of a different target labeling area. Then, the multiple pieces of sub-labeling information can be displayed in the first display area on the right toolbar of the graphical information of the analysis object; or the multiple pieces of sub-labeling information is displayed in the same row on the lower side of the graphical information of the analysis object, that is, in the second display area, and each piece of sub-labeling information is displayed in the position corresponding to the time range of the corresponding target labeling area.

As an implementable manner, the data labeling apparatus can control at least one target labeling area corresponding to the labeling information to be highlighted in response to the trigger operation performed by the user on the labeling information, so as to improve the user's processing efficiency and enable the user to view the performance defect segment more intuitively.

With the data labeling method provided in this embodiment, the labeling information corresponding to each target labeling area can be recorded accurately by completing the filling or editing operation of the operation execution interface according to the trigger operation performed by the user.

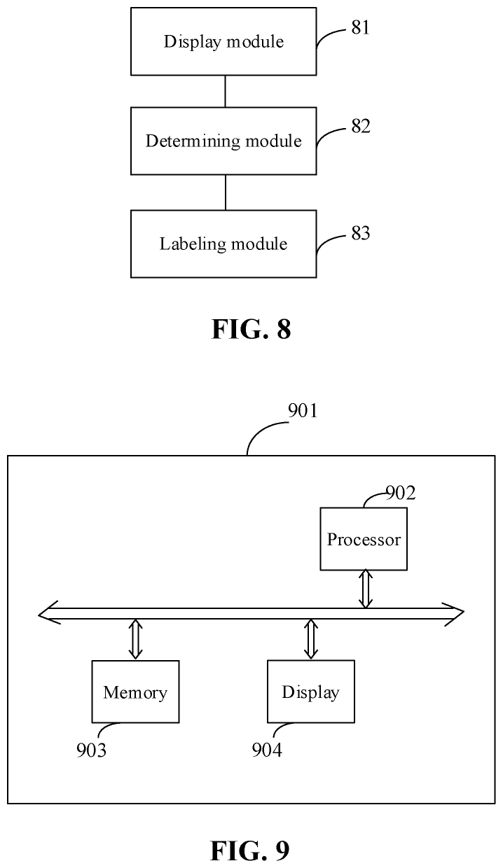

FIG. 8 is a schematic structural diagram of a data labeling apparatus provided by Embodiment 3 of the present disclosure. As shown in FIG. 8, the apparatus includes: a display module 81, a determining module 82 and a labeling module 83. The display module 81 is configured to: in response to a trigger operation performed by a user on a preset labeling button on a display interface, enter a labeling mode, the display interface including: graphical information of at least one analysis object arranged along a time axis. The determining module 82 is configured to: in response to a selection operation performed by the user on at least one time range of the graphical information corresponding to the at least one analysis object within the display interface, determine a target labeling area corresponding to the selection operation of each time range, each time range being used for representing a different time period on the time axis. The labeling module 83 is configured to: in response to a labeling operation on at least one target labeling area, generate labeling information corresponding to the at least one target labeling area.

Further, on the basis of Embodiment 3, the determining module is configured to: in response to at least one drag-selection operation performed by the user within the display interface, determine a start pixel point and an end pixel point of each drag-selection operation; for each drag-selection operation, determine a first timestamp corresponding to the start pixel point and a second timestamp corresponding to the end pixel point, and determine a corresponding time range according to the first timestamp and the second timestamp.

Further, on the basis of any one of the above embodiments, the graphical information corresponding to the at least one analysis object is sequentially arranged in rows in the display interface, and the graphical information corresponding to each analysis object extends along a direction of the time axis. The determining module is configured to determine a corresponding target labeling area by taking the time range as a width and taking a height occupied by the graphic information corresponding to all analysis objects as a length.

Further, on the basis of any one of the above embodiments, the analysis object is network analysis result data.

Further, on the basis of any one of the above embodiments, any two target labeling areas do not overlap.

Further, on the basis of any one of the above embodiments, the apparatus further includes:
a control module, configured to control the time axis to move in a lateral direction of the drag-selection operation, if it is detected that a pixel point where a cursor is located goes out of a current labeling range of the display interface during the drag-selection operation.

Further, on the basis of any one of the above embodiments, the apparatus further includes: a first adjusting module, configured to: in response to a drag-selection operation performed by the user on a left area boundary or a right area boundary of the target labeling area, adjust the time range corresponding to the target labeling area; or, a second adjusting module, configured to: in response to a trigger operation performed by the user on a preset direction key, adjust the time range corresponding to the target labeling area.

Further, on the basis of any one of the above embodiments, the second adjusting module is configured to: in response to the trigger operation performed by the user on the preset direction key, control an area boundary of the target labeling area which matches the direction key to move, to adjust the time range corresponding to the target labeling area; or, in response to a trigger operation performed by the user on any area boundary of the target labeling area and the trigger operation performed by the user on the preset direction key, control the area boundary to move in a direction corresponding to the direction key, to adjust the time range corresponding to the target labeling area.

Further, on the basis of any one of the above embodiments, the apparatus further includes: a processing module, configured to display a labeling operation execution interface of the target labeling area, the labeling operation execution interface including at least one of a tag type, a name, a time range, and remark information corresponding to the target labeling area; and/or, the apparatus further includes: a modifying module, configured to: in response to a trigger operation performed by the user on an edit control, display a modifying operation execution interface of the target labeling area, the modifying operation execution interface includes at least one of a tag type, a name, a time range, and remark information corresponding to the target labeling area.

Further, on the basis of any one of the above embodiments, the apparatus further includes: a first display module, configured to display the labeling information corresponding to the at least one target labeling area in a preset first display area; and/or, a second display module, configured to: for each piece of the labeling information, display, within a preset second display area, the labeling information at a position corresponding to the time range according to the time range in the labeling information.

FIG. 9 is a schematic structural diagram of an electronic device provided by Embodiment 4 of the present disclosure. As shown in FIG. 9, an electronic device 901 includes: at least one processor 902, a memory 903 and a display 904;
the processor 902, the memory 903 and the display 904 are interconnected through a circuit;
the memory 903 stores computer execution instructions; the display 904 is configured to display a display interface;
the at least one processor executes the computer execution instructions stored in the memory, to cause the at least one processor to execute the data labeling method described above and various possible designs thereof.

The device provided in this embodiment can be used to execute the technical solutions of the above method embodiments, and implementation principles and technical effects thereof are similar, which will not be repeated in this embodiment here.

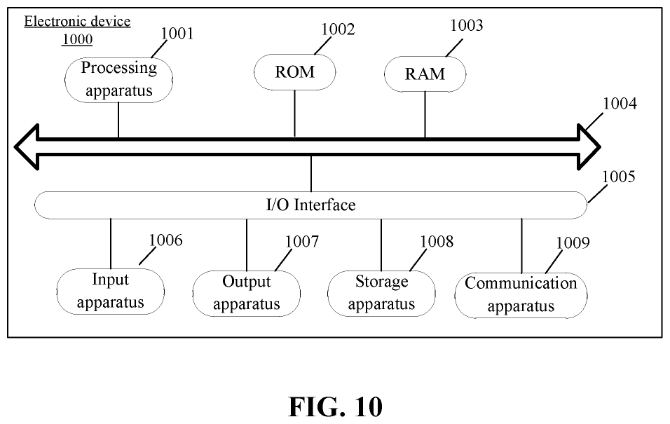

FIG. 10 is a schematic structural diagram of another electronic device provided by Embodiment 5 of the present disclosure. Referring to FIG. 10, which shows a schematic structural diagram of an electronic device 1000 suitable for implementing an embodiment of the present disclosure, the electronic device 1000 may be a terminal device or a server. The terminal device may include, but is not limited to, mobile terminals such as a mobile phone, a laptop, a digital broadcast receiver, a Personal Digital Assistant (PDA), a Portable Android Device (PAD), a Portable Media Player (PMP), a vehicle-mounted terminal (e.g., a vehicle navigation terminal), etc., and fixed terminals such as a digital TV, a desktop computer, etc. The electronic device shown in FIG. 10 is only an example, and should not bring any limitation to the functions and scope of use of the embodiments of the present disclosure.

As shown in FIG. 10, the electronic device 1000 may include a processing apparatus (such as a central processing unit, a graphics processing unit, etc.) 1001, which can perform various appropriate actions and processing according to a program stored in a Read Only Memory (ROM) 1002 or a program loaded into a Random Access Memory (RAM) 1003 from a storage apparatus 1008. In the RAM 1003, various programs and data necessary for operations of the electronic device 1000 are also stored. The processing apparatus 1001, the ROM 1002 and the RAM 1003 are connected to each other through a bus 1004. An Input/Output (I/O) interface 1005 is also connected to the bus 1004.

Generally, the following apparatuses can be connected to the I/O interface 1005: an input apparatus 1006 including, for example, a touch screen, a touchpad, a keyboard, a mouse, a camera, a microphone, an accelerometer, a gyroscope, etc.; an output apparatus 1007 including, for example, a Liquid Crystal Display (LCD), a speaker, a vibrator, etc.; the storage apparatus 1008 including, for example, a magnetic tape, a hard disk, etc.; and a communication apparatus 1009. The communication apparatus 1009 can allow the electronic device 1000 to perform wireless or wired communication with other devices to exchange data. While FIG. 10 shows the electronic device 1000 having various apparatuses, it should be understood that it is not required to implement or have all of the apparatus shown. More or fewer apparatuses may alternatively be implemented or provided.

Particularly, according to an embodiment of the present disclosure, a process described above with reference to a flowchart can be implemented as a computer software program. For example, an embodiment of the present disclosure includes a computer program product, which includes a computer program carried on a computer-readable medium, where the computer program includes program codes for executing the method shown in the flowchart. In such an embodiment, the computer program may be downloaded and installed from a network via the communication apparatus 1009, or installed from the storage apparatus 1008, or installed from the ROM 1002. When the computer program is executed by the processing apparatus 1001, the above functions defined in the method of the embodiment of the present disclosure are executed.

It should be noted that the above computer-readable medium of the present disclosure may be a computer-readable signal medium or a computer-readable storage medium or any combination of the above two. The computer-readable storage medium may be, for example, but not limited to, an electronic, magnetic, optical, electromagnetic, infrared or semiconductor system, apparatus or device, or any combination of the above. More specific examples of the computer-readable storage medium may include, but are not limited to, an electrical connection with one or more wires, a portable computer disk, a hard disk, a RAM, a ROM, an Erasable Programmable Read-Only Memory (EPROM or flash memory), an optical fiber, a Compact Disc-Read Only Memory (CD-ROM), an optical storage device, a magnetic storage device, or any suitable combination of the above. In the present disclosure, the computer-readable storage medium may be any tangible medium that contains or stores a program that can be used by or in connection with an instruction execution system, apparatus or device. In the present disclosure, the computer-readable signal medium may include a data signal propagated in a baseband or as part of a carrier wave, in which computer-readable program code is carried. Such propagated data signal can take various forms, including but not limited to an electromagnetic signal, an optical signal or any suitable combination of the above. The computer-readable signal medium may also be any computer-readable medium other than the computer-readable storage medium. The computer-readable signal medium can send, propagate or transmit a program for use by or in connection with the instruction execution system, apparatus or device. The program code contained on the computer-readable medium can be transmitted using any suitable medium, including but not limited to: an electric wire, an optical cable, a Radio Frequency (RF), etc., or any suitable combination of the above.

The above computer-readable medium may be included in the above electronic device, or may exist independently without being assembled into the electronic device.

The above computer-readable medium carries one or more programs, and when the one or more programs are executed by the electronic device, the electronic device is caused to execute the methods shown in the above embodiments.

The computer program code for performing the operations of the present disclosure may be written in one or more programming languages or their combinations. The above programming languages include object-oriented programming languages such as Java, Smalltalk, C++, and also conventional procedural programming languages such as “C” language or similar programming languages. The program code can be executed completely on a user computer, executed partially on the user computer, executed as an independent software package, executed partially on the user computer and partially on a remote computer, or executed completely on the remote computer or a server. In the case involving the remote computer, the remote computer can be connected to the user computer through any kind of networks, including a Local Area Network (LAN) or a Wide Area Network (WAN), or can be connected to an external computer (for example, being connected via the Internet using an Internet service provider).

Another embodiment of the present disclosure also provides a computer-readable storage medium. The computer-readable storage medium stores computer execution instructions therein, and when a processor executes the computer execution instructions, the data labeling method in any one of the above embodiments is implemented.

Another embodiment of the present disclosure further provides a computer program product including a computer program. When the computer program is executed by a processor, the data labeling method in any one of the above embodiments is implemented.

The flowcharts and block diagrams in the accompanying drawings illustrate architectures, functionalities and operations of possible implementations of the systems, methods and computer program products according to various embodiments of the present disclosure. In this regard, each block in the flowcharts or block diagrams may represent a module, a program segment, or a portion of code that contains one or more executable instructions for implementing the specified logic function. It should also be noted that, in some alternative implementations, the functions marked in the blocks may also occur in a different order from the order marked in the drawings. For example, two blocks shown in succession may, in fact, be executed substantially in parallel, or they may sometimes be executed in the reverse order, depending upon the functionality involved. It should also be noted that each block of the block diagrams and/or flowcharts, and combinations of blocks in the block diagrams and/or flowcharts, may be implemented by a dedicated hardware-based system that performs the specified functions or operations, or may be implemented by a combination of dedicated hardware and computer instructions.

The units involved in the embodiments described in the present disclosure may be implemented by software or hardware. The name of the unit does not constitute a limitation on the unit itself under certain circumstances. For example, the first obtaining unit may also be described as “a unit for obtaining at least two Internet protocol addresses”.

The functions described above may be performed at least partially by one or more hardware logic components. For example, without limitation, exemplary types of hardware logic components that can be used include: a Field Programmable Gate Array (FPGA), an Application Specific Integrated Circuit (ASIC), an Application Specific Standard Product (ASSP), a System on Chip (SOC), a Complex Programmable Logic Device (CPLD), etc.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination of the above. More specific examples of the machine-readable storage medium would include an electrical connection based on one or more wires, a portable computer disk, a hard disk, a RAM, a ROM, an EPROM or flash memory, an optical fiber, a CD-ROM, an optical storage device, a magnetic storage device, or any suitable combination of the above.

In a first aspect, according to one or more embodiments of the present disclosure, a data labeling method is provided, including: in response to a trigger operation performed by a user on a preset labeling button on a display interface, entering a labeling mode, the display interface including: graphical information of at least one analysis object arranged along a time axis; in response to a selection operation performed by the user on at least one time range of the graphical information corresponding to the at least one analysis object within the display interface, determining a target labeling area corresponding to the selection operation of each time range, each time range being used for representing a different time period on the time axis; in response to a labeling operation on at least one target labeling area, generating labeling information corresponding to the at least one target labeling area.

According to one or more embodiments of the present disclosure, determining the target labeling area corresponding to the selection operation of each time range in response to the selection operation performed by the user on the at least one time range of the graphical information corresponding to the at least one analysis object within the display interface includes: in response to at least one drag-selection operation performed by the user within the display interface, determining a start pixel point and an end pixel point of each drag-selection operation; for each drag-selection operation, determining a first timestamp corresponding to the start pixel point and a second timestamp corresponding to the end pixel point, and determining a corresponding time range according to the first timestamp and the second timestamp.

According to one or more embodiments of the present disclosure, the graphical information corresponding to the at least one analysis object is sequentially arranged in rows in the display interface, and the graphical information corresponding to each analysis object extends along a direction of the time axis; determining the target labeling area corresponding to the selection operation of each time range includes: determining a corresponding target labeling area by taking the time range as a width and taking a height occupied by the graphic information corresponding to all analysis objects as a length.

According to one or more embodiments of the present disclosure, the analysis object is network analysis result data.

According to one or more embodiments of the present disclosure, any two target labeling areas do not overlap.

According to one or more embodiments of the present disclosure, the method further includes: controlling the time axis to move in a lateral direction of the drag-selection operation, if it is detected that a pixel point where a cursor is located goes out of a current labeling range of the display interface during the drag-selection operation.

According to one or more embodiments of the present disclosure, after determining the target labeling area corresponding to the selection operation of each time range, the method further includes: in response to a drag-selection operation performed by the user on a left area boundary or a right area boundary of the target labeling area, adjusting the time range corresponding to the target labeling area; or, in response to a trigger operation performed by the user on a preset direction key, adjusting the time range corresponding to the target labeling area.

According to one or more embodiments of the present disclosure, adjusting the time range corresponding to the target labeling area in response to the trigger operation performed by the user on the preset direction key includes: in response to the trigger operation performed by the user on the preset direction key, controlling an area boundary of the target labeling area which matches the direction key to move, to adjust the time range corresponding to the target labeling area; or, in response to a trigger operation performed by the user on any area boundary of the target labeling area and the trigger operation performed by the user on the preset direction key, controlling the area boundary to move in a direction corresponding to the direction key, to adjust the time range corresponding to the target labeling area.

According to one or more embodiments of the present disclosure, after determining the target labeling area corresponding to the selection operation of each time range in response to the selection operation performed by the user on the at least one time range of the graphical information corresponding to the at least one analysis object within the display interface, the method further includes: displaying a labeling operation execution interface of the target labeling area, the labeling operation execution interface including at least one of a tag type, a name, a time range, and remark information corresponding to the target labeling area; and/or, after generating the labeling information corresponding to the at least one target labeling area, the method further includes: in response to a trigger operation performed by the user on an edit control, displaying a modifying operation execution interface of the target labeling area, the modifying operation execution interface including at least one of a tag type, a name, a time range, and remark information corresponding to the target labeling area.

According to one or more embodiments of the present disclosure, after generating the labeling information corresponding to the at least one target labeling area, the method further includes: displaying the labeling information corresponding to the at least one target labeling area in a preset first display area; and/or, for each piece of the labeling information, displaying, within a preset second display area, the labeling information at a position corresponding to the time range according to the time range in the labeling information.

In a second aspect, according to one or more embodiments of the present disclosure, a data labeling apparatus is provided, including: a display module, configured to: in response to a trigger operation performed by a user on a preset labeling button on a display interface, enter a labeling mode, the display interface including: graphical information of at least one analysis object arranged along a time axis; a determining module, configured to: in response to a selection operation performed by the user on at least one time range of the graphical information corresponding to the at least one analysis object within the display interface, determine a target labeling area corresponding to the selection operation of each time range, each time range being used for representing a different time period on the time axis; a labeling module, configured to: in response to a labeling operation on at least one target labeling area, generate labeling information corresponding to the at least one target labeling area.

According to one or more embodiments of the present disclosure, the determining module is configured to: in response to at least one drag-selection operation performed by the user within the display interface, determine a start pixel point and an end pixel point of each drag-selection operation; for each drag-selection operation, determine a first timestamp corresponding to the start pixel point and a second timestamp corresponding to the end pixel point, and determine a corresponding time range according to the first timestamp and the second timestamp.

According to one or more embodiments of the present disclosure, the graphical information corresponding to the at least one analysis object is sequentially arranged in rows in the display interface, and the graphical information corresponding to each analysis object extends along a direction of the time axis; the determining module is configured to: determine a corresponding target labeling area by taking the time range as a width and taking a height occupied by the graphic information corresponding to all analysis objects as a length.

According to one or more embodiments of the present disclosure, the analysis object is network analysis result data.

According to one or more embodiments of the present disclosure, any two target labeling areas do not overlap.

According to one or more embodiments of the present disclosure, the apparatus further includes: a control module, configured to control the time axis to move in a lateral direction of the drag-selection operation, if it is detected that a pixel point where a cursor is located goes out of a current labeling range of the display interface during the drag-selection operation.

According to one or more embodiments of the present disclosure, the apparatus further includes: a first adjusting module, configured to: in response to a drag-selection operation performed by the user on a left area boundary or a right area boundary of the target labeling area, adjust the time range corresponding to the target labeling area; or, a second adjusting module, configured to: in response to a trigger operation performed by the user on a preset direction key, adjust the time range corresponding to the target labeling area.

According to one or more embodiments of the present disclosure, the second adjusting module is configured to: in response to the trigger operation performed by the user on the preset direction key, control an area boundary of the target labeling area which matches the direction key to move, to adjust the time range corresponding to the target labeling area; or, in response to a trigger operation performed by the user on any area boundary of the target labeling area and the trigger operation performed by the user on the preset direction key, control the area boundary to move in a direction corresponding to the direction key, to adjust the time range corresponding to the target labeling area.

According to one or more embodiments of the present disclosure, the apparatus further includes: a processing module configured to display a labeling operation execution interface of the target labeling area, the labeling operation execution interface including at least one of a tag type, a name, a time range, and remark information corresponding to the target labeling area; and/or, according to one or more embodiments of the present disclosure, the apparatus further includes: a modifying module, configured to: in response to a trigger operation performed by the user on an edit control, display a modifying operation execution interface of the target labeling area, the modifying operation execution interface including at least one of a tag type, a name, a time range, and remark information corresponding to the target labeling area.

According to one or more embodiments of the present disclosure, the apparatus further includes: a first display module, configured to display the labeling information corresponding to the at least one target labeling area in a preset first display area; and/or, a second display module, configured to: for each piece of the labeling information, display, within a preset second display area, the labeling information at a position corresponding to the time range according to the time range in the labeling information.

In a third aspect, according to one or more embodiments of the present disclosure, an electronic device is provided, including: at least one processor, a memory and a display;
the processor, the memory and the display are interconnected through a circuit;
the memory stores computer execution instructions; the display is configured to display a display interface;
the at least one processor executes the computer execution instructions stored in the memory, to cause the at least one processor to execute the data labeling method according to the above first aspect and various possible designs of the first aspect.

In a fourth aspect, according to one or more embodiments of the present disclosure, a computer-readable storage medium is provided. The computer-readable storage medium stores computer execution instructions therein, and when a processor executes the computer execution instructions, the data labeling method according to the above first aspect and various possible designs of the first aspect is implemented.

In a fifth aspect, according to one or more embodiments of the present disclosure, a computer program product including a computer program is provided. When the computer program is executed by a processor, the method according to the above first aspect and various possible designs of the first aspect is implemented.

With the data labeling method, the apparatus, the device, the computer-readable storage medium and the product provided in the embodiments, the graphical information of at least one analysis object arranged along the time axis is displayed on the display interface. The labeling mode can be entered in response to the trigger operation performed by the user on the preset labeling button on the display interface, and under the labeling mode, the user can select at least one time range of the graphical information corresponding to the at least one analysis object, so as to determine the target labeling area corresponding to the selection operation of each time range. After the target labeling area is determined, the labeling information corresponding to at least one target labeling area can be generated in response to the labeling operation on the at least one target labeling area. The labeling information can include time selected by the user through interface interaction. In addition, the labeling information and the target labeling area can be displayed on the same display interface at the same time, which is convenient for a technician to analyze and process a performance defect segment subsequently.

The above description is only preferred embodiments of the present disclosure and an illustration of the applied technical principles. Those skilled in the art should understand that the disclosure scope involved in the present disclosure is not limited to the technical solutions formed by the specific combinations of the above technical features, but should also cover other technical solutions formed by any combination of the above technical features or their equivalent features without departing from the above disclosed concept, for example, technical solutions formed by interchanging the above features with (but not limited to) the technical features with similar functions disclosed in the present disclosure.

In addition, while operations are depicted in a particular order, this should not be understood as requiring that the operations be performed in the particular order shown or performed in sequential order. Under certain circumstances, multitasking and parallel processing may be advantageous. Likewise, while the above discussion contains several specific implementation details, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the appended claims is not necessarily limited to the specific features or actions described above. Rather, the specific features and actions described above are merely exemplary forms of implementations of the claims.

What is claimed is:

1. A data labeling method, comprising:
in response to a trigger operation on a preset labeling button on a display interface, entering a labeling mode, the display interface comprising: graphical information corresponding to at least one analysis object arranged along a time axis;
in response to a selection operation on at least one time range of the graphical information corresponding to the at least one analysis object within the display interface, determining a target labeling area corresponding to the selection operation of each time range, wherein each time range is used for representing a different time period on the time axis;
in response to a labeling operation on at least one target labeling area, generating labeling information corresponding to the at least one target labeling area.

2. The method according to claim 1, wherein determining the target labeling area corresponding to the selection operation of each time range in response to the selection operation on the at least one time range of the graphical information corresponding to the at least one analysis object within the display interface comprises:
in response to at least one drag-selection operation within the display interface, determining a start pixel point and an end pixel point of each drag-selection operation;
for each drag-selection operation, determining a first timestamp corresponding to the start pixel point and a second timestamp corresponding to the end pixel point, and determining a corresponding time range according to the first timestamp and the second timestamp.

3. The method according to claim 2, wherein the graphical information corresponding to the at least one analysis object is sequentially arranged in rows in the display interface, and the graphical information corresponding to each analysis object extends along a direction of the time axis;
determining the target labeling area corresponding to the selection operation of each time range comprises:
determining a corresponding target labeling area by taking the time range as a width and taking a height occupied by the graphic information corresponding to all analysis objects as a length.

4. The method according to claim 1, wherein the analysis object is network analysis result data.

5. The method according to claim 1, wherein any two target labeling areas do not overlap.

6. The method according to claim 2, further comprising:
controlling the time axis to move in a lateral direction of the drag-selection operation, if it is detected that a pixel point where a cursor is located goes out of a current labeling range of the display interface during the drag-selection operation.

7. The method according to claim 1, after determining the target labeling area corresponding to the selection operation of each time range, further comprising:
in response to a drag-selection operation on a left area boundary or a right area boundary of the target labeling area, adjusting the time range corresponding to the target labeling area; or,
in response to a trigger operation on a preset direction key, adjusting the time range corresponding to the target labeling area.

8. The method according to claim 7, wherein adjusting the time range corresponding to the target labeling area in response to the trigger operation on the preset direction key comprises:
in response to the trigger operation on the preset direction key, controlling an area boundary of the target labeling area which matches the direction key to move, to adjust the time range corresponding to the target labeling area;
or,
in response to a trigger operation on any area boundary of the target labeling area and the trigger operation on the preset direction key, controlling the area boundary to move in a direction corresponding to the direction key, to adjust the time range corresponding to the target labeling area.

9. The method according to claim 1, after determining the target labeling area corresponding to the selection operation of each time range in response to the selection operation on the at least one time range of the graphical information corresponding to the at least one analysis object within the display interface, further comprising:
displaying a labeling operation execution interface of the target labeling area, the labeling operation execution interface comprising at least one of a tag type, a name, a time range, and remark information corresponding to the target labeling area; and/or,
after generating the labeling information corresponding to the at least one target labeling area, further comprising:
in response to a trigger operation on an edit control, displaying a modifying operation execution interface of the target labeling area, the modifying operation execution interface comprising at least one of a tag type, a name, a time range, and remark information corresponding to the target labeling area.

10. The method according to claim 8, after generating the labeling information corresponding to the at least one target labeling area, further comprising:
displaying the labeling information corresponding to the at least one target labeling area in a preset first display area; and/or,
for each piece of the labeling information, displaying, within a preset second display area, the labeling information at a position corresponding to the time range according to the time range in the labeling information.

11. A data labeling apparatus, comprising: at least one processor, a memory and a display;
the memory stores computer execution instructions; the display is configured to display a display interface;
the at least one processor executes the computer execution instructions to cause the processor to:
in response to a trigger operation on a preset labeling button on a display interface, enter a labeling mode, the display interface comprising: graphical information corresponding to at least one analysis object arranged along a time axis;
in response to a selection operation on at least one time range of the graphical information corresponding to the at least one analysis object within the display interface, determine a target labeling area corresponding to the selection operation of each time range, wherein each time range is used for representing a different time period on the time axis;
in response to a labeling operation on at least one target labeling area, generate labeling information corresponding to the at least one target labeling area.

12. (canceled)

13. A non-transitory computer-readable storage medium, wherein the computer-readable storage medium stores computer execution instructions therein, and when a processor executes the computer execution instructions, the processor executes steps of:
in response to a trigger operation on a preset labeling button on a display interface, entering a labeling mode, the display interface comprising: graphical information corresponding to at least one analysis object arranged along a time axis;
in response to a selection operation on at least one time range of the graphical information corresponding to the at least one analysis object within the display interface, determining a target labeling area corresponding to the selection operation of each time range, wherein each time range is used for representing a different time period on the time axis;
in response to a labeling operation on at least one target labeling area, generating labeling information corresponding to the at least one target labeling area.

14. (canceled)

15. The apparatus according to claim 11, wherein the at least one processor executes the computer execution instructions to cause the processor to:
in response to at least one drag-selection operation within the display interface, determine a start pixel point and an end pixel point of each drag-selection operation;
for each drag-selection operation, determine a first timestamp corresponding to the start pixel point and a second timestamp corresponding to the end pixel point, and determine a corresponding time range according to the first timestamp and the second timestamp.

16. The apparatus according to claim 15, wherein the graphical information corresponding to the at least one analysis object is sequentially arranged in rows in the display interface, and the graphical information corresponding to each analysis object extends along a direction of the time axis;
the at least one processor executes the computer execution instructions to cause the processor to:
determine a corresponding target labeling area by taking the time range as a width and taking a height occupied by the graphic information corresponding to all analysis objects as a length.

17. The apparatus according to claim 11, wherein the analysis object is network analysis result data.

18. The apparatus according to claim 11, wherein any two target labeling areas do not overlap.

19. The apparatus according to claim 15, wherein the processor executes the computer execution instructions to further cause the processor to:
control the time axis to move in a lateral direction of the drag-selection operation, if it is detected that a pixel point where a cursor is located goes out of a current labeling range of the display interface during the drag-selection operation.

20. The apparatus according to claim 16, wherein after determining the target labeling area corresponding to the selection operation of each time range, the processor executes the computer execution instructions to further cause the processor to:
in response to a drag-selection operation on a left area boundary or a right area boundary of the target labeling area, adjust the time range corresponding to the target labeling area; or,
in response to a trigger operation on a preset direction key, adjust the time range corresponding to the target labeling area;
wherein the processor executes the computer execution instructions to specifically cause the processor to:
in response to the trigger operation on the preset direction key, control an area boundary of the target labeling area which matches the direction key to move, to adjust the time range corresponding to the target labeling area;
or,
in response to a trigger operation on any area boundary of the target labeling area and the trigger operation on the preset direction key, control the area boundary to move in a direction corresponding to the direction key, to adjust the time range corresponding to the target labeling area.

21. The apparatus according to claim 11, wherein after determining the target labeling area corresponding to the selection operation of each time range in response to the selection operation on the at least one time range of the graphical information corresponding to the at least one analysis object within the display interface, the processor executes the computer execution instructions to further cause the processor to:
display a labeling operation execution interface of the target labeling area, the labeling operation execution interface comprising at least one of a tag type, a name, a time range, and remark information corresponding to the target labeling area; and/or,
wherein after generating the labeling information corresponding to the at least one target labeling area, the processor executes the computer execution instructions to further cause the processor to:
in response to a trigger operation on an edit control, displaying a modifying operation execution interface of the target labeling area, the modifying operation execution interface comprising at least one of a tag type, a name, a time range, and remark information corresponding to the target labeling area.

22. The apparatus according to claim 20, wherein after generating the labeling information corresponding to the at least one target labeling area, the processor executes the computer execution instructions to further cause the processor to:
display the labeling information corresponding to the at least one target labeling area in a preset first display area; and/or,
for each piece of the labeling information, display, within a preset second display area, the labeling information at a position corresponding to the time range according to the time range in the labeling information.
